(19) United States
(12) Patent Application Publication
(10) Pub. No.: US 2018/0186990 A1
(43) Pub. Date: Jul. 5, 2018

(54) COMPOSITE MATERIAL FOR HIGH-IMPACT POLYVINYL CHLORIDE REINFORCED PIPE

(71) Applicant: YONGGAO CO., LTD., Taizhou (CN)

(72) Inventors: Zhenyu LU, Taizhou (CN); Jian Huang, Taizhou (CN); Zhiyong Chen, Taizhou (CN); Wei Chen, Taizhou (CN); Huali Sun, Taizhou (CN); Pengyue Wang, Taizhou (CN)

(73) Assignee: YONGGAO CO., LTD, Taizhou (CN)

(21) Appl. No.: 15/642,441

(22) Filed: Jul. 6, 2017

(30) Foreign Application Priority Data
Dec. 31, 2016 (CN) 201611267644.2

(51) Int. Cl. C08L 27/06

(52) U.S. Cl. CPC C08L 27/06; C08L 2203/18; F16L 9/12; C08L 2205/03; C08L 2310/00

(57) ABSTRACT

The present invention relates to a composite material for high-impact polyvinyl chloride reinforced pipe, belonging to the polymer materials technology field. In order to solve the shortcomings of rigidity and toughness of the existing materials, the present invention provides a composite material for high-impact polyvinyl chloride reinforced pipe, comprising: polyvinyl chloride resin: 100; heat stabilizer: 2.0˜8.0; lubricant: 0.1˜7.0; processing modifier: 0.1˜5; composite toughening agent: 8˜50. The composite toughening agent is a masterbatch mainly composed of an elastic polymer, a dispersant and a nano-montmorillonite, and mass ratio of elastic polymer:dispersant:nano-montmorillonite in the composite toughening agent is 58˜85:0.1˜12:10˜30. By adding the composite toughening agent and preparing it by pre-compounding of elastic polymer, dispersant and nano-montmorillonite, the composite material can have a cushioning effect and improve the compatibility, achieving the advantages of rigidity and toughness at the same time.

### CROSS-REFERENCE TO RELATED APPLICATION

This application claims priority to Chinese patent application No. 201611267644.2, titled “COMPOSITE MATERIAL FOR HIGH-IMPACT POLYVINYL CHLORIDE REINFORCED PIPE”, filed with the Chinese State Intellectual Property Office on Dec. 31, 2016, the entire contents of which are incorporated herein by reference.

### FIELD

The present invention relates to a composite material for high-impact polyvinyl chloride reinforced pipe, belonging to the polymer materials technology field.

### BACKGROUND

Polyvinyl chloride is currently one of the five main general plastics. Polyvinyl chloride pipe becomes the most widely used type of pipe due to its low cost, simple processing and convenient construction.

Hard polyvinyl chloride (PVC-U) reinforced pipe is a new pipe having a smooth inner wall and an outer wall with a vertical reinforcement, made of hard polyvinyl chloride as the main raw material. Its has the following main performances: the strength and stiffness thereof can bear the load under the geographical environment; the hydraulic characteristics thereof is suitable for conveying liquid; no leaking, preventing environmental pollution; wear resistance and easy installation, therefore with a comprehensive economy advantage. It is mainly used for underground sewage system and drainage system. Since the principle of I-beam steel is applied to its outer wall, polyvinyl chloride reinforced pipes have a unique performance advantage. The product has been widely used in the drainage system and sewage system in developed countries since the eighties, and it gradually replaced the traditional cement pipes, steel pipes and so on, becoming the world's most advanced material for buried drainage and sewage pipes. Due to the properties of the material itself and the special structure of the pipe, PVC-U reinforced pipe has a high strength and rigidity. However, it has shortcomings such as easy to break, poor toughness and so on, so it shows obvious deficiencies in the seismic resistance, uneven foundation settlement resistance, anti-point load and so on. These shortcomings greatly limit its application and promotion. Therefore, it is necessary to modify the PVC materials to improve the performances of the materials. For example, Chinese patent application (Publication No. CN105778355A) disclosed a low density impact resistant modified polyvinyl chloride pipe and its production process, which used a polyvinyl chloride resin as a base material and enhanced the toughness and low temperature impact resistance of the composite material by adding polymer hollow beads. However, the polymer hollow bead has a high cost and is hard to process in the production process, so it is not suitable for industrialized production.

### SUMMARY

In view of the above drawbacks of the prior art, the present invention provides a composite material for high-impact polyvinyl chloride reinforced pipe to solve the problem of how to impart high rigidity and toughness to the materials.

The object of the present invention is achieved by the following technical solution which provides a composite material for high-impact polyvinyl chloride reinforced pipe, comprising the following components in parts by weight:

polyvinyl chloride resin: 100; heat stabilizer: 2.0˜8.0; lubricant: 0.1˜7.0; processing modifier: 0.1˜5; and composite toughening agent: 8˜50;

said composite toughening agent is a masterbatch mainly composed of an elastic polymer, a dispersant and a nano-montmorillonite; and mass ratio of elastic polymer:dispersant:nano-montmorillonite in said composite toughening agent is 58˜85:0.1˜12:10˜30.

The composite material for high-impact polyvinyl chloride reinforced pipe of the present invention uses polyvinyl chloride resin as main material. The composite toughening agent is prepared by pre-compounding of elastic polymer, dispersant and nano-montmorillonite, causing the dispersant to insert into layers of nano-montmorillonite or to coat on the surface of nano-montmorillonite. This can organically modify nano-montmorillonite, improve the layer spacing of nano-montmorillonite, so that it has a good compatibility. Furthermore, an elastomer adheres or coats on the surface of the nano-montmorillonite or interposes between the layers so as to be able to give a cushioning effect and to improve the compatibility. Herein, the raw materials in the composite toughening agent are formulated by using composite toughening agent as the reference for mass ratio, then added as materials according to the ratio. After the composite toughening agent and polyvinyl chloride are mixed, when external force is applied, the elastomer in the composite toughening agent can absorb a large amount of external energy by its own deformation. Nano-montmorillonite can act as the stress concentration body, causing the surrounding matrix to produce a large number of micro-cracks, and forcing the plastic deformation of the matrix, absorbing external energy, so that elastomer and nano-montmorillonite can achieve the effect of synergistic toughening. At the same time, these make the PVC-M reinforced tubes produced not only meet the requirements of strength and stiffness, but also greatly improve the impact performance, giving it excellent resistance to stress cracking, to crack growth and anti-point load capacity, so that it can effectively resist to external force impact during transport, installation and use.

In the above-mentioned composite material for high-impact polyvinyl chloride reinforced pipe, preferably, the composite toughening agent is obtained through preprocessing by the following method:

The nano-montmorillonite and dispersant are mixed; the elastic polymer is added and mixed until the elastomer becomes soft and adheres to or covers the surface of the nano-montmorillonite to obtain the corresponding composite toughening agent. Pre-processed composite toughening agents can make nano-montmorillonite to be coated inside the elastomer. The elastic polymer on the surface can create a very good cushioning effect, and the internal nano-montmorillonite can act as a stress concentration body to cause the plastic deformation of surrounding matrix, so that it has a double impact resistance performance, achieving a better impact strength effect.

In the composite material for high-impact polyvinyl chloride reinforced pipe, preferably, said elastic polymer is selected from one or more of acrylonitrile-butadiene-styrene copolymer (ABS), chlorinated polyethylene (CPE), methyl methacrylate-butadiene-styrene terpolymer (MBS), methyl methacrylate-acrylonitrile-butadiene-styrene copolymer (MABS), 1,3-butadiene-methyl methacrylate copolymer (AMB), ethylene-vinyl acetate copolymer (EVA), ACM resin (acrylate resin) and acrylate impact modifier (AIM). They have a good flexibility, so that can more effectively play a cushioning effect, and improve the impact resistance of materials. More preferably, the elastic polymer is a mixture of acrylonitrile-butadiene-styrene copolymer, 1,3-butadiene-methyl methacrylate copolymer and methyl methacrylate-acrylonitrile-butadiene-styrene copolymer, and mass ratio of acrylonitrile-butadiene-styrene copolymer:1,3-butadiene-methyl methacrylate copolymer:methyl methacrylate-acrylonitrile-butadiene-styrene copolymer is 1:0.5˜0.8:0.5˜1.0.

In the composite material for high-impact polyvinyl chloride reinforced pipe, preferably, said nano-montmorillonite is selected from Ca-montmorillonite or Na-montmorillonite. They have a better layer structure which makes dispersant to insert into the layer structure of nano-montmorillonite better. After it is mixed into the base material, it can function as a stress concentration body better, so that the matrix can play a role in plastic deformation, thereby further improve the performances of rigidity and impact resistance.

In the composite material for high-impact polyvinyl chloride reinforced pipe, preferably, said dispersant is selected from one or more of dimeric glyceryl oleate, dimeric glyceryl laurate, polyoxyethylene sorbitan fatty acid ester and polyoxyethylene monostearate glyceride. The above dispersants have good chemical, thermodynamic stability and antistatic properties. Also, they are hydrophilic and lipophilic, so that the ether oxygen bond on the molecular chain of the dispersant can form hydrogen bonds with the nano-montmorillonite surface-OH, so that the dispersant can be more efficiently coated onto the surface of the nano-montmorillonite or insert into the layer structure of nano-montmorillonite, so that the surface property of nano-montmorillonite is changed from hydrophilicity to lipophilicity. At the same time, the dispersants can increase the layer spacing. These greatly improve the dispersibility and compatibility of nano-montmorillonite, so that the elastic polymer can be better coated or adhered to the surface of nano-montmorillonite, improving the rigidity and toughness of the material. More preferably, the dispersant is a mixture of dimeric glyceryl oleate, polyoxyethylene monostearate and dimeric glyceryl laurate, and the percentage of said dimeric glyceryl oleate is 4 wt %˜5 wt %, and the mass ratio of the dimeric glyceryl oleate:polyoxyethylene monostearate glyceride:dimeric glyceryl laurate is 1:0.5˜0.6:0.4˜0.5. This can improve the ring stiffness of the composite material better and improve the impact strength remarkably. More preferably, the mass ratio of the dispersant:nanometer montmorillonite is 1:2.5˜3.0.

In the composite material for high-impact polyvinyl chloride reinforced pipe, preferably, said lubricant includes internal lubricant and external lubricant; the weight part of said internal lubricant is 0.1˜3.0; and the weight part of said external lubricant is 0.1˜4.0. Lubricant can make the materials have a good lubrication performance, more important, improves the strength property of the materials, and also gives the surface of the product a good smoothness. More preferably, said internal lubricant is selected from one of stearic acid and its derivatives, polyol fatty acid ester, fatty amide, polyol or a mixture thereof; said external lubricant is selected from one of polyoxyethylene wax, polyethylene wax, Fischer-Tropsch wax, polyether wax, montan wax, or a mixture thereof. The raw materials of these lubricants are relatively easy to obtain, so it is conducive to industrialized production.

In the composite material for high-impact polyvinyl chloride reinforced pipe, preferably, said processing modifier is selected from one of acrylate polymer and styrene-acrylonitrile copolymer, or a mixture thereof.

In the composite material for high-impact polyvinyl chloride reinforced pipe, preferably, said heat stabilizer is selected from one or more of composite lead heat stabilizer, calcium and zinc heat stabilizer, organotin heat stabilizer and non-metallic organic heat stabilizer. More preferably, said non-metallic organic heat stabilizer is selected from one of 6-amino-1,3-dimethyluracil, 2-phenylindole, β-aminocrotonate, triphenylurea, or a mixture thereof. Heat stabilizer can improve the thermal stability of the materials, effectively prevent the heat decomposition of PVC resin during processing, and ensure the rigidity and toughness performances of the materials.

As described above, the present invention has the following advantages over the prior art:

1. The composite material for high-impact polyvinyl chloride reinforced pipe of the present invention uses a composite toughening agent which is prepared by pre-compounding of elastic polymer, dispersant and nano-montmorillonite, to give a cushioning effect and to improve the compatibility, wherein nano-montmorillonite can act as the stress concentration body, so that the PVC-M reinforced pipes produced not only meet the requirements of strength and stiffness, but also have a great improvement on the impact performance, giving it excellent resistance to stress cracking, to crack growth and anti-point load capacity, so that it can effectively resist to external force impact during transport, installation and use.

2. The composite material for high-impact polyvinyl chloride reinforced pipe of the present invention uses a dispersant with ether oxygen bonds on the molecular chain, which can form hydrogen bonds with the surface-OH of nano-montmorillonite, so that the dispersant can more efficiently coat onto the surface of the nano-montmorillonite or insert into the layer structure of nano-montmorillonite, changing the surface property of nano-montmorillonite from hydrophilicity to lipophilicity. At the same time, the dispersants can increase the layer spacing. These greatly improve the dispersibility and compatibility of nano-montmorillonitea, achieving the effect of improving the rigidity and toughness of the materials.

3. The composite material for high-impact polyvinyl chloride reinforced pipe of the present invention, by using a mixture of dimeric glyceryl oleate, polyoxyethylene monostearate glyceride and dimeric glyceryl laurate, and controlling the percentage of dimeric glyceryl oleate, makes it work synergistically with nano-montmorillonite added, so as to improve the ring stiffness of the composite more effectively and improve the impact strength remarkably.

### DETAILED DESCRIPTION OF EMBODIMENTS

Hereinafter, the technical solutions of the present invention will be described in further detail with reference to specific examples, but the present invention is not limited to these examples.

### Example 1

Polyvinyl chloride resin SG-5: 100; composite lead heat stabilizer FJ-304B: 2.7; internal lubricant pentaerythritol stearate: 0.5; external lubricant montan wax: 0.2; ACR PA-21: 0.8; composite toughening agent: 14.5.

The composite toughening agent was previously processed by the following method:

Using composite toughening agent as the reference, according to the raw material mass percentages in the composite toughening agent, 4 wt % dimeric glyceryl oleate and 30 wt % nano-montmorillonite were added to the high speed mixer and mixed for 10 minutes; 27 wt % ACM resin and 35 wt % MBS B-564 were added and mixing was continued for 3˜8 minutes; the composite toughening agent was obtained after discharge. It was used by mixing with other materials in the matrix according to the adding amount.

The specific preparation method for the high-impact polyvinyl chloride reinforced pipe using the composite material mentioned above was as below:

The corresponding raw materials were weighed according to the weight part of each raw material, fed into the high and low speed mixer, and mixed under high-speed and hot mixing condition for 8˜12 minutes; when the temperature reached 125˜155° C., low-speed cold mixing was carried out; when the temperature was dropped to 45˜65° C., the mixture was discharged and mixed evenly to obtain the corresponding PVC-M mixed material. The PVC-M mixed material was added to the extruder for extrusion molding, and then through cutting, flaring and other processes to obtain PVC-M reinforced tube (DN225 mm).

### Example 2

Polyvinyl chloride resin SG-5: 100; calcium and zinc heat stabilizer: 2.0; internal lubricant stearic acid: 0.5; external lubricant polyoxyethylene wax: 0.2; processing modifier ACR PA-21: 0.8; composite toughening agent: 14.5.

The composite toughening agent was previously processed by the following methods:

Using composite toughening agent as the reference, according to the raw material mass percentages in the composite toughening agent, 6 wt % polyoxyethylene sorbitan fatty acid ester and 20 wt % nano-montmorillonite were added to the high speed mixer and mixed for 10 minutes; 20 wt % chlorinated polyethylene and 54 wt % methyl methacrylate-acrylonitrile-butadiene-styrene copolymer were added and mixing was continued for 3˜8 minutes; the composite toughening agent was obtained after discharge. It was used by mixing with other materials in the matrix according to the adding amount.

The specific preparation method for the high-impact polyvinyl chloride reinforced pipe using the composite material mentioned above was the same as the method in Example 1 and thus is not repeated here.

### Example 3

Polyvinyl chloride resin SG-5: 100; organotin heat stabilizer: 4.0; internal lubricant fatty amide: 3.0; outer lubricant Fischer-Tropsch wax: 1.0; processing modifier styrene-acrylonitrile copolymer: 0.1; composite toughening agent: 50; pigment: 5.0, wherein the color of the pigment can be adjusted and selected according to actual needs.

The composite toughening agent was previously processed by the following method:

Using composite toughening agent as the reference, according to the raw material mass percentages in the composite toughening agent, 5.0 wt % Polyoxyethylene monostearate glyceride and 10 wt % Ca-based nano-montmorillonite were added to the high speed mixer and mixed for 10 minutes; 40 wt % ethylene-vinyl acetate copolymer and 45 wt % methyl methacrylate-butadiene-styrene terpolymer were added and mixing was continued for 3˜8 minutes; the composite toughening agent was obtained after discharge. It was used by mixing with other materials in the matrix according to the adding amount.

The specific preparation method for the high-impact polyvinyl chloride reinforced pipe using the composite material mentioned above was the same as the method in Example 1 and thus is not repeated here.

### Example 4

Polyvinyl chloride resin SG-5: 100; calcium and zinc heat stabilizer: 5.0; internal lubricant polyol fatty acid ester: 2.0; external lubricant polyethylene wax: 4.0; processing modifier styrene-acrylonitrile copolymer: 2.0; composite toughening agent: 40; pigment: 2.0, wherein the color of the pigment can be adjusted and selected according to actual needs.

The composite toughening agent was previously processed by the following method:

Using composite toughening agent as the reference, according to the raw material mass percentages in the composite toughening agent, 10 wt % polyoxyethylene monostearate glyceride and 15 wt % Ca-based nano-montmorillonite were added to the high speed mixer and mixed for 10 minutes; 35 wt % ethylene-vinyl acetate copolymer and 40 wt % methyl methacrylate-butadiene-styrene terpolymer were added and mixing was continued for 3˜8 minutes; the composite toughening agent was obtained after discharge. It was used by mixing with other materials in the matrix according to the adding amount.

The specific preparation method for the high-impact polyvinyl chloride reinforced pipe using the composite material mentioned above was the same as the method in Example 1 and thus is not repeated here.

### Example 5

Polyvinyl chloride resin SG-5: 100; 6-amino-1,3-dimethyluracil: 4.0; composite lead heat stabilizer FJ-304B: 2.0; internal lubricant polyol fatty acid ester: 1.0; external lubricant polyester wax: 3.0; processing modifier styrene-acrylonitrile copolymer: 1.0; composite toughening agent: 40; pigment: 3.0, wherein the color of the pigment can be adjusted and selected according to actual needs.

The composite toughening agent was previously processed by the following method:

Using composite toughening agent as the reference, according to the raw material mass percentages in the composite toughening agent, 5 wt % polyoxyethylene monostearate glyceride and 30 wt % Na-based nano-montmorillonite were added to the high speed mixer and mixed for 10 minutes; 65 wt % 1,3-butadiene-methyl methacrylate copolymer was added and mixing was continued for 3˜8 minutes; the composite toughening agent was obtained after discharge. It was used by mixing with other materials in the matrix according to the adding amount.

The specific preparation method for the high-impact polyvinyl chloride reinforced pipe using the composite material mentioned above was the same as the method in Example 1 and thus is not repeated here.

### Example 6

Polyvinyl chloride resin SG-5: 100; calcium and zinc heat stabilizer: 2.0; triphenylurea: 6.0; internal lubricant stearic acid: 0.1; external lubricant polyethylene wax: 2.0; external lubricant Fischer-Tropsch wax: 1.0; processing modifier acrylate polymer: 0.1; composite toughening agent: 30; pigment: 3.0, wherein the color of the pigment can be adjusted and selected according to actual needs.

The composite toughening agent was previously processed by the following method:

Using composite toughening agent as the reference, according to the raw material mass percentages in the composite toughening agent, 0.1 wt % polyoxyethylene monostearate glyceride and 30 wt % Na-based nano-montmorillonite were added to the high speed mixer and mixed for 10 minutes; 69.9 wt % ethylene-vinyl acetate copolymer was added and mixing was continued for 3˜8 minutes; the composite toughening agent was obtained after discharge. It was used by mixing with other materials in the matrix according to the adding amount.

The specific preparation method for the high-impact polyvinyl chloride reinforced pipe using the composite material mentioned above was the same as the method in Example 1 and thus is not repeated here.

### Example 7

Polyvinyl chloride resin SG-5: 100; 6-amino-1,3-dimethyluracil: 4.0; β-aminocrotonate: 2.0; calcium and zinc heat stabilizer: 2.0; internal lubricant ethylene glycol: 0.1; external lubricant polyoxyethylene wax: 0.1; processing modifier acrylate polymer: 2.50; composite toughening agent: 20; pigment: 4.0, wherein the color of the pigment can be adjusted and selected according to actual needs.

The composite toughening agent was previously processed by the following method:

Using composite toughening agent as the reference, according to the raw material mass percentages in the composite toughening agent, 10 wt % dimeric glyceryl laurate and 10 wt % Na-based nano-montmorillonite were added to the high speed mixer, wherein the specific surface area of the Na-based nano-montmorillonite was 50˜1000 m²/g, the average wafer thickness was less than 50 nanometers, and the montmorillonite content is greater than 95%; after mixing for 10 minutes, 80 wt % ethylene-vinyl acetate copolymer was added and mixing was continued for 3˜8 minutes; the composite toughening agent was obtained after discharge. It was used by mixing with other materials in the matrix according to the adding amount.

The specific preparation method for the high-impact polyvinyl chloride reinforced pipe using the composite material mentioned above was the same as the method in Example 1 and thus is not repeated here.

### Example 8

Polyvinyl chloride resin SG-5: 100; composite lead heat stabilizer FJ-304B: 3.0; internal lubricant calcium stearate: 2.0; external lubricant polyether wax: 1.0; processing modifier acrylate polymer: 2.50; processing modifier styrene-acrylonitrile copolymer: 1.0; composite toughening agent: 25; pigment: 4.0, wherein the color of the pigment can be adjusted and selected according to actual needs.

The composite toughening agent was previously processed by the following method:

Using composite toughening agent as the reference, according to the raw material mass percentages in the composite toughening agent, 8 wt % dimeric glyceryl laurate, 4 wt % polyoxyethylene monostearate glyceride and 20 wt % Ca-based nano-montmorillonite were added to the high speed mixer, wherein the specific surface area of the Ca-based nano-montmorillonite was 50˜1000 m²/g, the average wafer thickness was less than 50 nanometers, and the montmorillonite content is greater than 95%. After mixing for 10 minutes, 68 wt % methyl methacrylate-butadiene-styrene terpolymer was added and mixing was continued for 3˜8 minutes; the composite toughening agent was obtained after discharge. It was used by mixing with other materials in the matrix according to the adding amount.

The specific preparation method for the high-impact polyvinyl chloride reinforced pipe using the composite material mentioned above was the same as the method in Example 1 and thus is not repeated here.

### Example 9

Polyvinyl chloride resin SG-5: 100; β-amino crotonate: 3.0; calcium and zinc heat stabilizer: 1.0; internal lubricant calcium stearate: 2.0; external lubricant PE wax: 1.5; processing modifier acrylate polymer: 2.50; composite toughening agent: 25; pigment: 3.0, wherein the color of the pigment can be adjusted and selected according to actual needs.

The composite toughening agent was previously processed by the following method:

Using composite toughening agent as the reference, according to the raw material mass percentages in the composite toughening agent, 5 wt % dimeric glyceryl laurate, 2.5 wt % polyoxyethylene monostearate glyceride, 2.0 wt % dimeric glyceryl laurate and 23.7 wt % Ca-based nano-montmorillonite were added to the high speed mixer, wherein the specific surface area of the Ca-based nano-montmorillonite was 50˜1000 m²/g, the average wafer thickness was less than 50 nanometers, and the montmorillonite content is greater than 95%. After mixing for 10 minutes, 66.8 wt % methyl methacrylate-butadiene-styrene terpolymer was added and mixing was continued for 3˜8 minutes; the composite toughening agent was obtained after discharge. It was used by mixing with other materials in the matrix according to the adding amount.

The specific preparation method for the high-impact polyvinyl chloride reinforced pipe using the composite material mentioned above was the same as the method in Example 1 and thus is not repeated here.

### Example 10

Polyvinyl chloride resin SG-5: 100;

2-phenylindole: 2.0;

Calcium and zinc heat stabilizer: 3.0;

Internal lubricant stearate calcium: 3.0;

External Lubricant Fischer-Tropsch Wax: 2.0;

Processing modifier acrylate polymers: 2.50;

Composite toughening agent: 40;

Pigment: 3.0, wherein the color of the pigment can be adjusted and selected according to actual needs.

The composite toughening agent was previously processed by the following method:

Using composite toughening agent as the reference, according to the raw material mass percentages in the composite toughening agent, 3 wt % dimeric glyceryl laurate, 5.0 wt % polyoxyethylene monostearate glyceride, 4.0 wt % dimeric glyceryl laurate and 30 wt % Ca-based nano-montmorillonite were added to the high speed mixer, wherein the specific surface area of the Ca-based nano-montmorillonite was 50˜1000 m²/g, the average wafer thickness was less than 50 nanometers, and the montmorillonite content is greater than 95%. After mixing for 10 minutes, 58 wt % methyl methacrylate-butadiene-styrene terpolymer was added and mixing was continued for 3˜8 minutes; the composite toughening agent was obtained after discharge. It was used by mixing with other materials in the matrix according to the adding amount.

The specific preparation method for the high-impact polyvinyl chloride reinforced pipe using the composite material mentioned above was the same as the method in Example 1 and thus is not repeated here.

### Comparative Example 1

Polyvinyl chloride resin SG-5: 100;

Composite lead heat stabilizer FJ-304B: 2.5;

Stearic acid: 0.7;

PE wax: 0.3;

ACR PA-21: 1.0;

Calcium carbonate: 7;

Pigment was added according to actual needs.

The specific preparation method of using the composite material mentioned above for polyvinyl chloride reinforced pipe was as below:

The corresponding raw materials were weighed according to the weight part of each raw material, fed into the high and low speed mixer, and mixed under high-speed and hot mixing condition for 8˜12 minutes; when the temperature reached 125˜155° C., low-speed cold mixing was carried out; when the temperature was dropped to 45˜65° C., the mixture was discharged and mixed evenly to obtain the corresponding PVC-M mixed material. The PVC-M mixed material was added to the extruder for extrusion molding, and then through cutting, flaring and other processes to obtain PVC-M reinforced tube (DN225 mm).

### Comparative Example 2

In this example, nano-montmorillonite and dispersant were added and mixed with matrix materials directly, without being mixed previously to make composite toughening agent, which was illuminated and compared here.

Polyvinyl chloride resin SG-5: 100; composite lead heat stabilizer FJ-304B: 2.6; internal lubricant pentaerythritol stearate: 0.5; external lubricant Montan wax: 0.2; ACR PA-21: 0.8; nano-montmorillonite: 5.0; dimeric glyceryl oleate: 0.6; ACM resin: 9.4; pigment: 2.0, wherein the color of the pigment can be adjusted and selected according to actual needs.

The specific preparation method of using the composite material mentioned above for polyvinyl chloride reinforced pipe was as below:

The corresponding raw materials were weighed according to the weight part of each raw material, fed into the high and low speed mixer, and mixed under high-speed and hot mixing condition for 8˜12 minutes; when the temperature reached 125˜155° C., low-speed cold mixing was carried out; when the temperature was dropped to 45˜65° C., the mixture was discharged and mixed evenly to obtain the corresponding PVC-M mixed material. The PVC-M mixed material was added to the extruder for extrusion molding, and then through cutting, flaring and other processes to obtain PVC-M reinforced tube (DN225 mm).

The corresponding pipe products made from the composite materials of the present invention in the examples were randomly selected and the corresponding properties of these products were tested. The specific test results were shown in Tables 1 to 3.

TABLE 1

| | sample | | | |
|---|---|---|---|---|
| item | Example 1 | Example 2 | Example 3 | Example 4 |
| density (g/m³) | 1.42 | 1.43 | 1.43 | 1.52 |
| ring stiffness | 8.4 | 8.5 | 8.3 | 8.6 |
| (KN/m²) | | | | |
| ring flexibility | qualified | qualified | qualified | qualified |
| vicat softening | 80.1 | 80.5 | 81.2 | 80.7 |
| temperature | | | | |
| (° C.) | | | | |
| 0° C. drop hammer | ≤10 | ≤10 | ≤10 | ≤10 |
| impact TIR²⁾ | | | | |
| (%) | | | | |
| 0° C. drop hammer | ≤10 | ≤10 | ≤10 | ≤10 |
| impact TIR³⁾ | | | | |
| (%) | | | | |
| −10° C. drop hammer | ≤10 | ≤10 | ≤10 | ≤10 |
| impact TIR⁴⁾ | | | | |
| (%) | | | | |

Part of the test in above Table 1 and below Tables 2 and 3 was carried out according to GB/T14152-2001 standard.

In addition, 0° C. drop hammer impact TIR²⁾ means the test conditions for 0° C. drop hammer impact is: hammer head d90 type, hammer mass 2 kg, and drop height 2 m;

0° C. drop hammer impact TIR³⁾ means the test conditions for 0° C. drop hammer impact is: hammer head d90 type, hammer mass 5.5 kg, and drop height 2 m;

−10° C. drop hammer impact TIR⁴⁾ means the test conditions for 0° C. drop hammer impact is: hammer head d90 type, hammer mass 10 kg, and drop height 0.5 m.

TABLE 2

| | sample | | | |
|---|---|---|---|---|
| item | Example 5 | Example 6 | Example 7 | Example 8 |
| density (g/m³) | 1.48 | 1.45 | 1.46 | 1.43 |
| ring stiffness (KN/m²) | 8.2 | 8.5 | 8.4 | 8.3 |
| ring flexibility | qualified | qualified | qualified | qualified |
| vicat softening | 80.6 | 80.8 | 81.0 | 80.5 |
| temperature | | | | |
| (° C.) | | | | |
| 0° C. drop hammer | ≤10 | ≤10 | ≤10 | ≤10 |
| impact TIR²⁾ | | | | |
| (%) | | | | |
| 0° C. drop hammer | ≤10 | ≤10 | ≤10 | ≤10 |
| impact TIR³⁾ | | | | |
| (%) | | | | |
| −10° C. drop hammer | ≤10 | ≤10 | ≤10 | ≤10 |
| impact TIR⁴⁾ | | | | |
| (%) | | | | |

Table 3 below was the properties test results of the corresponding pipe products made from the composite materials in Examples 10 and 11, and Comparative Examples 1 and 2.

TABLE 3

| | sample | | | |
|---|---|---|---|---|
| | | | | Com- |
| | Example | Example | Comparative | parative |
| item | 10 | 11 | Example 1 | Example 2 |
| density (g/m³) | 1.42 | 1.41 | 1.42 | 1.41 |
| ring stiffness | 10.2 | 9.8 | 7.3 | 6.8 |
| (KN/m²) | | | | |
| ring flexibility | qualified | qualified | qualified | qualified |
| vicat softening | 83.5 | 84.2 | 80.1 | 80.2 |
| temperature | | | | |
| (° C.) | | | | |
| 0° C. drop hammer | ≤10 | ≤10 | >10 | >10 |
| impact TIR²⁾ | | | | |
| (%) | | | | |
| 0° C. drop hammer | ≤10 | ≤10 | >10 | >10 |
| impact TIR³⁾ | | | | |
| (%) | | | | |
| −10° C. drop hammer | ≤10 | ≤10 | >10 | >0 |
| impact TIR⁴⁾ | | | | |
| (%) | | | | |

The test results in Table 1, Table 2 and Table 3 showed that there was remarkable difference in material properties of the products which didn't use the composite toughening agent of the present invention, in particular in the drop hammer test. Herein, standard technical requirement of drop hammer test is ≤10%. The results demonstrated that using the composite toughening agent of the present invention can effectively improve the overall performance of materials, ensuring the anti-external damage capacity of the reinforced pipes made from the composite material of the present invention. It overcomes the problems of PVC-U reinforced pipes such as easy to break, poor toughness, greatly improves the anti-earthquake performance and anti-risk ability of reinforced pipes, and effectively decreases the requirement of construction environment.

The specific examples described in the present invention are merely used to illustrate the spirit of the present invention. Those skilled in the art can make various modification or changes or replacements to the specific examples without departing the spirit of the present invention or beyond the scope of the present invention.

Although the present invention has been described in detail and a number of examples have been cited, it is apparent that those skilled in the art can make various modification or changes without departing the spirit and scope of the present invention.

1. A composite material for high-impact polyvinyl chloride reinforced pipe, comprising the following components in parts by weight:
polyvinyl chloride resin: 100; heat stabilizer: 2.0˜8.0; lubricant: 0.1˜7.0; processing modifier: 0.1˜5; and composite toughening agent: 8˜50;
wherein said composite toughening agent is a masterbatch mainly composed of an elastic polymer, a dispersant and a nano-montmorillonite, and mass ratio of elastic polymer:dispersant:nano-montmorillonite in the composite toughening agent is 58˜85:0.1˜12:10˜30.

2. The composite material for high-impact polyvinyl chloride reinforced pipe of claim 1, wherein said composite toughening agent is obtained through preprocessing by the following method:
nano-montmorillonite and dispersant are mixed; elastic polymer is added and mixed until the elastomer becomes soft and adheres to or covers the surface of the nano-montmorillonite to obtain the corresponding composite toughening agent.

3. The composite material for high-impact polyvinyl chloride reinforced pipe of claim 1, wherein said elastic polymer is selected from one or more of acrylonitrile-butadiene-styrene copolymer, chlorinated polyethylene, methyl methacrylate-butadiene-styrene terpolymer, methyl methacrylate-acrylonitrile-butadiene-styrene copolymer, 1,3-butadiene-methyl methacrylate copolymer, ethylene-vinyl acetate copolymer and ACM resin.

4. The composite material for high-impact polyvinyl chloride reinforced pipe of claim 1, wherein said nano-montmorillonite is selected from Ca-montmorillonite or Na-montmorillonite.

5. The composite material for high-impact polyvinyl chloride reinforced pipe of claim 1, wherein said dispersant is selected from one or more of dimeric glyceryl oleate, dimeric glyceryl laurate, polyoxyethylene sorbitan fatty acid ester and polyoxyethylene monostearate glyceride.

6. The composite material for high-impact polyvinyl chloride reinforced pipe of claim 1, wherein said lubricant includes internal lubricant and external lubricant; the weight parts of said internal lubricant is 0.1˜3.0; and the weight parts of said external lubricant is 0.1˜4.0.

7. The composite material for high-impact polyvinyl chloride reinforced pipe of claim 6, wherein said internal lubricant is selected from one of stearic acid and its derivatives, polyol fatty acid ester, fatty amide, polyol, or a mixture thereof; and said external lubricant is selected from one of polyoxyethylene wax, polyethylene wax, Fischer-Tropsch wax, polyether wax, montan wax, or a mixture thereof.

8. The composite material for high-impact polyvinyl chloride reinforced pipe of claim 1, wherein said processing modifier is selected from one of acrylate polymer and styrene-acrylonitrile copolymer, or a mixture thereof.

9. The composite material for high-impact polyvinyl chloride reinforced pipe of claim 1, wherein said heat stabilizer is selected from one or more of composite lead heat stabilizer, calcium and zinc heat stabilizer, organotin heat stabilizer and non-metallic organic heat stabilizer.

10. The composite material for high-impact polyvinyl chloride reinforced pipe of claim 9, wherein said non-metallic organic heat stabilizer is selected from one of 6-amino-1,3-dimethyluracil, 2-phenylindole, β-aminocrotonate, triphenylurea, or a mixture thereof.
